(19) United States
(12) Patent Application Publication
(10) Pub. No.: US 2026/0290701 A1
(43) Pub. Date: Sep. 24, 2026

(54) MULTILAYER CERAMIC CAPACITOR

(71) Applicant: TAIYO YUDEN CO., LTD., Tokyo (JP)

(72) Inventor: Ryo ITO, Tokyo (JP)

(21) Appl. No.: 19/548,302

(22) Filed: Feb. 24, 2026

(30) Foreign Application Priority Data
Mar. 24, 2025 (JP) 2025-048799

(51) Int. Cl. H01G 4/30; H01G 4/12

(52) U.S. Cl. CPC H01G 4/30; H01G 4/1227

(57) ABSTRACT

A multilayer ceramic capacitor includes a base body in which a dielectric layer and an internal electrode layer are alternately laminated in a first axial direction, wherein the dielectric layer includes a perovskite-type compound represented by a general formula ABO₃ and needle-shaped particles containing silicon (Si) and aluminum (Al), a thickness of the dielectric layer is 0.6 μm or less, and in a cross-sectional view taken by cutting the multilayer ceramic capacitor along the first axial direction, a ratio Lps/Ln of a total projected length Lps of the needle-shaped particles to a longitudinal length Ln of the internal electrode layer is 1% or more and less than 30%, the total projected length Lps being a sum of projected lengths of the needle-shaped particles in the cross-sectional view when projected along the first axial direction onto a plane perpendicular to the first axial direction.

### CROSS-REFERENCE TO RELATED APPLICATION

The present application is based on and claims priority to Japanese patent application No. 2025-048799 filed on Mar. 24, 2025, with the Japan Patent Office, the entire contents of which are hereby incorporated by reference.

### BACKGROUND OF THE INVENTION

### 1. Field of the Invention

The disclosures herein relate to multilayer ceramic capacitors.

### 2. Description of the Related Art

A multilayer ceramic capacitor (MLCC) has a structure in which dielectric layers and internal electrode layers are alternately laminated. Multilayer ceramic capacitors are used in various electronic devices such as cellular phones and personal computers.

In recent years, as electronic devices have become increasingly multifunctional and higher in performance, there has been a demand for miniaturization and improved mechanical strength of multilayer ceramic capacitors. To meet such a demand, it is effective to increase the number of layers by thinning the dielectric layer and the internal electrode layer, or to increase the strength by adding needle-shaped particles containing silicon (Si) and aluminum (Al) to the dielectric layer (e.g., see Patent Literature (PTL) 1).

However, in conventional multilayer ceramic capacitors including the invention described in PTL 1, the needle-shaped particles may penetrate the internal electrodes and extend over a plurality of layers in accordance with thinning of the dielectric layer and the internal electrode layer. In such a structure, there was a concern that the needle-shaped particles interfere with the internal electrodes and deform, and a distance between the internal electrodes becomes close, which may cause abnormal electrical characteristics such as a short circuit. In addition, in such a structure, there was a concern that fringing of the electric field, which may occur as the dielectric layer and the internal electrode layer are thinned, could be inhibited by needle-shaped particles, resulting in a decrease in electrostatic capacitance.

The present disclosure aims to provide a multilayer ceramic capacitor having high strength and excellent electrical characteristics.

### CITATION LIST

### Patent Literature

[PTL 1] Japanese Laid-Open Patent Publication No. 2023-042562

### SUMMARY OF THE INVENTION

A multilayer ceramic capacitor includes a base body in which a dielectric layer and an internal electrode layer are alternately laminated in a first axial direction, wherein the dielectric layer includes a perovskite-type compound represented by a general formula ABO₃ and needle-shaped particles containing silicon (Si) and aluminum (Al), a thickness of the dielectric layer is 0.6 μm or less, and in a cross-sectional view taken by cutting the multilayer ceramic capacitor along the first axial direction, a ratio Lps/Ln of a total projected length Lps of the needle-shaped particles to a longitudinal length Ln of the internal electrode layer is 1% or more and less than 30%, the total projected length Lps being a sum of projected lengths of the needle-shaped particles in the cross-sectional view when projected along the first axial direction onto a plane perpendicular to the first axial direction.

According to one aspect of the present disclosure, a multilayer ceramic capacitor having high strength and excellent electrical characteristics can be provided.

### BRIEF DESCRIPTION OF THE DRAWINGS

FIG. 1 is a perspective view illustrating a multilayer ceramic capacitor according to one embodiment of the present disclosure;

FIG. 2 is a cross-sectional view taken along a line A-A of FIG. 1;

FIG. 3 is a cross-sectional view taken along a line B-B of FIG. 1;

FIG. 4 is a schematic diagram illustrating a shape of a needle-shaped particle in one embodiment of the present disclosure;

FIG. 5 is an enlarged schematic view illustrating a region C in FIG. 2; and

FIG. 6 is a flowchart illustrating a method of manufacturing the multilayer ceramic capacitor according to one embodiment.

### DESCRIPTION OF THE PREFERRED EMBODIMENT

In the following, an embodiment of the present disclosure (hereinafter, referred to as “the present embodiment” will be described in detail, but the present disclosure is not limited to this. In the present disclosure and the drawings, components having substantially the same functional configuration are denoted by the same reference numerals, thereby omitting redundant descriptions. In the drawings, an X-axis, a Y-axis, and a Z-axis orthogonal to each other are shown as appropriate. The X-axis, Y-axis, and Z-axis define a fixed coordinate system fixed to the multilayer ceramic capacitor. The X-axis, Y-axis, and Z-axis can correspond to the length, width, and height of the multilayer ceramic capacitor, which is an example of a multilayer ceramic electronic component, when the outer shape of the multilayer ceramic capacitor is a substantially rectangular prism.

### [Basic Structure of Multilayer Ceramic Capacitor]

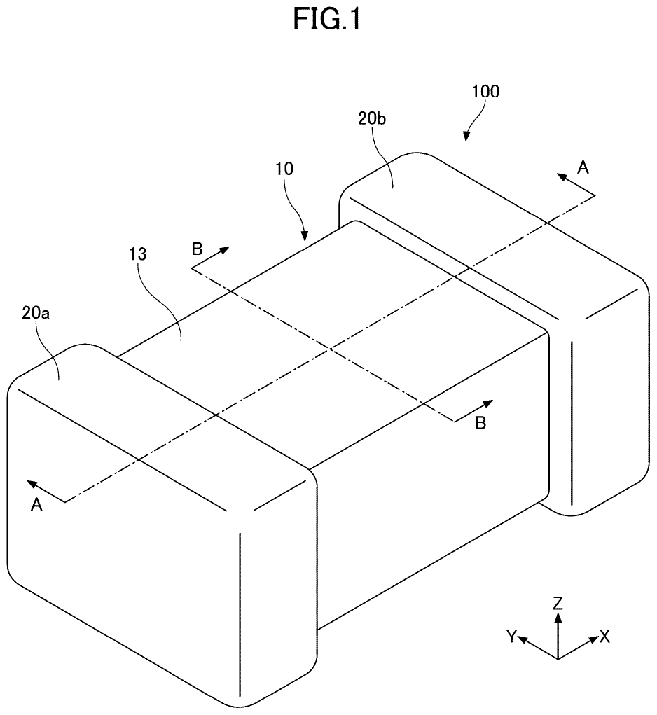

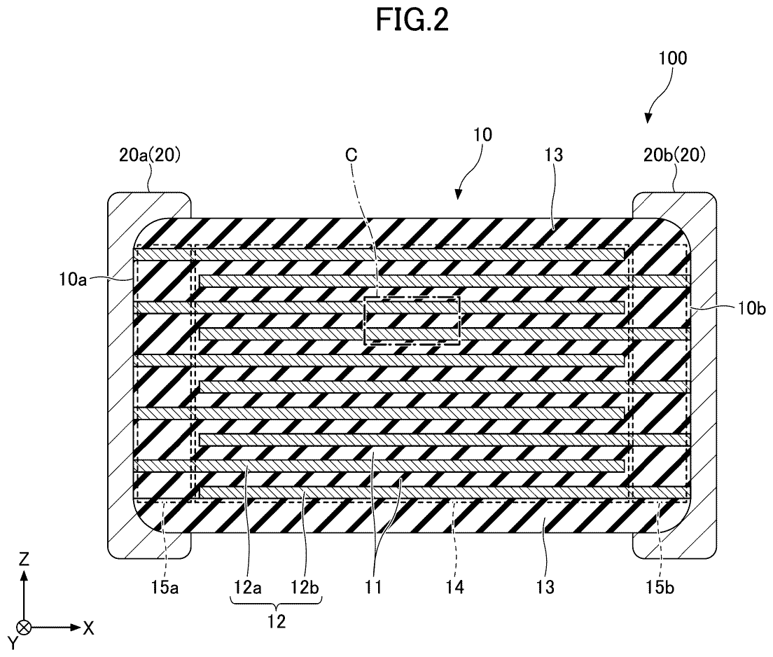

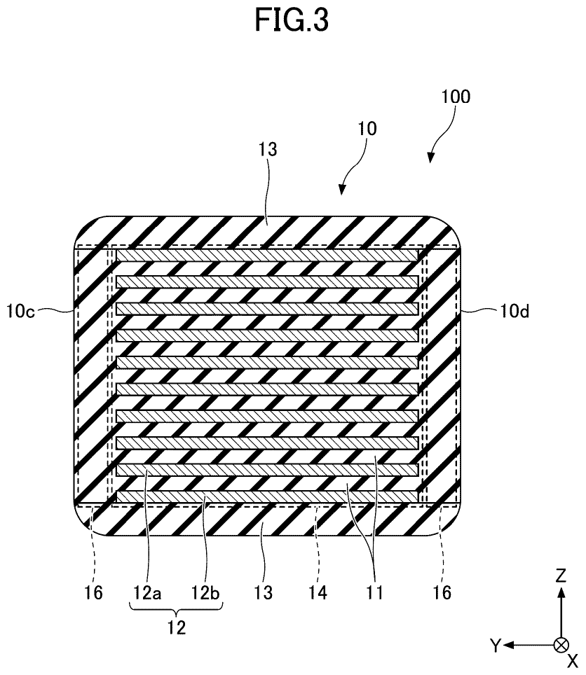

FIG. 1 is a perspective view illustrating a multilayer ceramic capacitor 100 according to one embodiment of the present disclosure. FIG. 2 is a cross-sectional view taken along a line A-A of FIG. 1. FIG. 3 is a cross-sectional view taken along a line B-B of FIG. 1.

As shown in FIGS. 1 to 3, the multilayer ceramic capacitor 100 includes a base body 10 having a substantially rectangular prism shape. In the base body 10, two opposing surfaces of the base body 10 are referred to as an upper surface and a lower surface, and four surfaces connecting the upper surface and the lower surface are referred to as lateral surfaces, respectively. Generally, when a multilayer ceramic capacitor is mounted on a circuit board, a surface on a substrate side is referred to as a lower surface, but it is not limited to this.

In the example shown in FIGS. 1 to 3, a first external electrode 20a and a second external electrode 20b are provided on a first lateral surface 10a and a second lateral surface 10b (see FIG. 2), which are two opposing lateral surfaces of the base body 10, respectively.

The first external electrode 20a extends from the first lateral surface 10a to four surfaces adjacent to the first lateral surface 10a. The second external electrode 20b extends from the second lateral surface 10b to four surfaces adjacent to the second lateral surface 10b. The first external electrode 20a and the second external electrode 20b are separated from each other. The external electrodes may be provided not only on the surfaces of the base body 10 but also on the two opposing lateral surfaces.

The base body 10 has a structure in which a dielectric layer 11 including a ceramic material and needle-shaped particles functioning as a dielectric and an internal electrode layer 12 are alternately laminated in a first axial direction.

The internal electrode layer 12 includes a plurality of first internal electrode layers 12a and a plurality of second internal electrode layers 12b. The first internal electrode layer 12a and the second internal electrode layer 12b are alternately laminated in the first axial direction. The edge of the first internal electrode layer 12a extends to and is exposed at a surface of the base body 10 on which the first external electrode 20a is provided, namely, the first lateral surface 10a in FIGS. 1 to 3. The edge of the second internal electrode layer 12b extends to the surface of the base body 10 on which the second external electrode 20b is provided, that is, the second lateral surface 10b in FIGS. 1 to 3. As a result, the first internal electrode layer 12a and the second internal electrode layer 12b are alternately conductive to the first external electrode 20a and the second external electrode 20b. Therefore, the multilayer ceramic capacitor 100 has a configuration in which a plurality of capacitor units are laminated. The number of layers of the dielectric layer 11 and the number of layers of the internal electrode layer 12 in FIGS. 1 to 3 are merely examples for ease of explanation, and the multilayer ceramic capacitor according to the present embodiment may be formed by laminating a larger number of layers.

A lamination direction in which the dielectric layer 11 and the internal electrode layer 12 are laminated is a first axial direction. As shown in FIGS. 1 to 3, when the first axial direction as the lamination direction is a direction along the Z-axis in a fixed coordinate system (Z-axial direction), the Z-axis is the lamination direction in which the dielectric layer 11 and the internal electrode layer 12 are laminated, and the internal electrode layers face each other.

An axis perpendicular to the first axis as the lamination direction is a second axis. As shown in FIGS. 1 to 3, when the second axis perpendicular to the first axis as the lamination direction is a direction along the X-axis (X-axial direction), the X-axis is a direction in which the internal electrode layer 12 is drawn out, and the first lateral surface 10a and the second lateral surface 10b of the base body 10 face each other, or the first external electrode 20a and the second external electrode 20b face each other. In the example shown in FIGS. 1 to 3, this electrode drawing direction (X-axial direction) is a direction along the longitudinal direction of the base body 10.

An axis perpendicular to the first axis as the lamination direction and perpendicular to the second axis is a third axis. As shown in FIGS. 1 to 3, when the third axis perpendicular to the first axis as the lamination direction and perpendicular to the second axis is a direction along the Y-axis (Y-axial direction), the Y-axis is an axis along a direction in which a third lateral surface 10c and a fourth lateral surface 10d of the four lateral surfaces of the base body 10 face each other, and in the example shown in FIGS. 1 to 3, it is a direction along the width direction of the base body 10.

The X-axial direction, the Y-axial direction, and the Z-axial direction are orthogonal to each other. The lamination direction is not limited to the Z-direction but can be any direction. Therefore, for example, the first axis as the lamination direction may be the X-axis of the X-direction or the Y-axis of the Y-direction.

In the present disclosure, drawings illustrating a specific embodiment may be used for the purpose of explaining a general embodiment. However, descriptions made with reference to a coordinate axis system used in such a specific embodiment shall be interpreted, in the general embodiment, as being based on a general coordinate system in which a lamination direction is defined as a first axis. For example, in FIGS. 1 to 3 illustrating a specific embodiment in which the lamination direction coincides with the Z-direction, axes described as the X-axis, the Y-axis, and the Z-axis may be correspondingly interpreted, in the general embodiment, as a second axis, a third axis, and the first axis, respectively.

A region where the first internal electrode layer 12a connected to the first external electrode 20a and the second internal electrode layer 12b connected to the second external electrode 20b face each other is referred to as a capacitance part 14. The capacitance part 14 is a region that generates electric capacitance in the multilayer ceramic capacitor 100. In other words, the capacitance part 14 is a region where adjacent internal electrode layers connected to different external electrodes face each other via a dielectric layer.

In the capacitance part 14 where the dielectric layer 11 and the internal electrode layer 12 are laminated, the outermost portion in the lamination direction (Z-axial direction) includes the internal electrode layer 12. Further, a cover layer 13 may be disposed on the outer surface of the capacitance part 14 in the lamination direction, that is, on the outer surface of the outermost internal electrode layer 12 in the lamination direction.

The cover layer 13 is a layer containing a ceramic material functioning as a dielectric and may have the same composition as that of the dielectric layer 11 or may have a different composition.

The configuration of the base body 10 is not limited to that shown in FIGS. 1 to 3, as long as the first internal electrode layer 12a and the second internal electrode layer 12b are exposed in different regions of the surface of the base body 10 and are electrically connected to different external electrodes. The different regions of the surface of the base body 10 may be respective surface regions of opposing surfaces of the surface of the base body 10, respective surface regions of adjacent surfaces, or different surface regions of the same surface. As long as the different external electrodes are separated from each other, the first internal electrode layer 12a and the second internal electrode layer 12b may extend from a surface exposed in the surface region of the laminated body to another surface.

A region in which the first internal electrode layers 12a connected to the first external electrode 20a face each other in the lamination direction without the second internal electrode layer 12b connected to the second external electrode 20b being interposed therebetween is referred to as a first end margin 15a. A region in which the second internal electrode layers 12b connected to the second external electrode 20b face each other in the lamination direction without the first internal electrode layer 12a connected to the first external electrode 20a being interposed therebetween is referred to as a second end margin 15b. Each end margin is a region in which internal electrode layers connected to the same external electrode face each other in the lamination direction without internal electrode layers connected to different external electrodes being interposed therebetween. The first end margin 15a and the second end margin 15b are regions that do not generate electric capacitance.

As shown in FIG. 3, a region provided adjacent to the outside of the capacitance part 14 in the Y-axial direction is referred to as a side margin 16. The side margin is a region adjacent to the capacitance part 14 on the side where the internal electrode layer 12 is not drawn out. The side margin 16 is a region that does not generate electric capacitance.

The size of the multilayer ceramic capacitor 100 is not particularly limited and can be appropriately selected according to the purpose, and may be, for example, 0.25 mm in length, 0.125 mm in width, 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. However, the listed sizes of the multilayer ceramic capacitor 100 are merely exemplary, and the multilayer ceramic capacitor is not limited to the above sizes.

The size of the multilayer ceramic capacitor 100 may be, for example, length>width≥height, width>length≥height, height>length≥width, or height>width≥length. The ceramic capacitor 100 shown in FIGS. 1 to 3 has a length in the X-axial direction (electrode drawing direction), a width in the Y-axial direction, and a height in the Z-axial direction (lamination direction).

### (Dielectric Layer)

### <Perovskite Compound>

The dielectric layer 11 contains a compound having a perovskite structure represented by the general formula ABO₃ (also referred to as a perovskite-type compound) as a main component. In the present disclosure, the phrase “containing a predetermined component as a main component” means that, among components contained in the dielectric layer 11, the predetermined component is contained in the largest proportion on an amount-of-substance basis.

The content of the perovskite-type compound in the dielectric layer 11 is not particularly limited and can be appropriately selected according to the purpose, and may contain, for example, 50 at % or more, 60 at % or more, 80 at % or more, 90 at % or more, or 95 at % or more. The perovskite structure may be oxygen-deficient relative to a stoichiometric composition. That is, the perovskite-type compound may be expressed as ABO_{3-α} deviating from the stoichiometric composition (0≤α≤1:α represents an amount deviating from the stoichiometric composition).

As the perovskite-type compound, for example, one or more of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming a perovskite structure may be used.

Specific examples of Ba_{1-x-y}CaₓSr_{y}Ti_{1-z}Zr_{z}O₃ include barium strontium titanate, barium calcium titanate, barium zirconate, barium zirconate titanate, calcium zirconate titanate, and barium calcium zirconate titanate.

Among these perovskite-type compounds, barium titanate (BaTiO₃) is preferable from the viewpoint of excellent dielectric properties such as high dielectric constant and low dielectric loss. When the dielectric layer 11 contains barium titanate as a perovskite-type compound, electrostatic capacitance of the multilayer ceramic capacitor 100 can be enhanced. The ceramic material of the dielectric layer 11 preferably contains barium titanate as a main component and may be composed of only barium titanate.

Barium titanate can generally be obtained by reacting a titanium raw material such as titanium dioxide with a barium raw material such as barium carbonate.

The method for synthesizing the ceramic powder to be the ceramic material as the main component of the dielectric layer 11 is not particularly limited, and can be appropriately selected according to the purpose, and includes, for example, a solid-phase method, a sol-gel method, and a hydrothermal method.

### <Needle-Shaped Particle>

The dielectric layer 11 includes needle-shaped particles containing silicon (Si) and aluminum (Al). When the dielectric layer 11 contains needle-shaped particles, the strength of the multilayer ceramic capacitor is improved. In addition, during a firing process described later, the presence of the needle-shaped particles between particles controls against necking between base particles, and stabilization of the firing process is achieved due to inhibitory effect on grain growth.

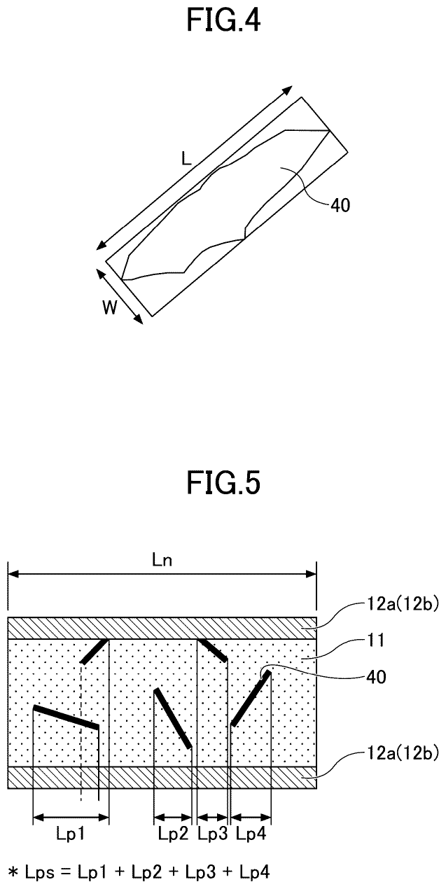

Here, the term “needle-shaped particle” as used herein refers to a particle having a length L of 0.05 μm or more and 5 μm or less and an aspect ratio (L/W) of three or more. As shown in FIG. 4, in calculating the value of the length L and the aspect ratio (L/W), the values obtained when the length of the long side is referred to as L and the length of the short side is referred to as W in a rectangle circumscribing the target particle when viewed in cross section are adopted.

The method for specifying the needle-shaped particles 40 in the dielectric layer 11 is not particularly limited, and can be appropriately selected according to the purpose, and can be measured, for example, by the following method. Using a scanning electron microscope (SEM) capable of identifying a composition of a sample based on a backscattered electron image, a partial cross section including an internal electrode layer of a YZ-plane or an XZ-plane of a multilayer ceramic capacitor is observed, and needle-shaped particles having a composition different from that of the dielectric material can be identified from a contrast difference in the backscattered electron image. Prior to observation by the SEM, the multilayer ceramic capacitor is cut by, for example, an ion milling method to obtain a smooth cross section suitable for observation.

The composition of the needle-shaped particles 40 is not particularly limited as long as it contains silicon (Si) and aluminum (Al), and can be appropriately selected according to the purpose. Specific examples include 3Al₂O₃·2SiO₂ and Al₂SiO₇.

In the multilayer ceramic capacitor according to the present embodiment, in a cross-sectional view taken by cutting the multilayer ceramic capacitor along the first axial direction, a ratio Lps/Ln of a total projected length Lps of the needle-shaped particles 40 projected along the first axial direction to a longitudinal length Ln of the internal electrode layer 12 (hereinafter, sometimes referred to as a “total projected length ratio Lps/Ln”) is 1% or more and less than 30%. For convenience, the total projected length ratio Lps/Ln is expressed as a value obtained by dividing the total projected length Lps by the length Ln and multiplying by 100, that is, as a percentage. A more specific description will be given with reference to FIG. 5.

FIG. 5 is an enlarged schematic view illustrating a region C in FIG. 2. The “cross-sectional view of the multilayer ceramic capacitor cut along the first axial direction” may be a YZ cross-section or an XZ cross-section as shown in FIG. 2. The term “longitudinal direction of the internal electrode layer 12” refers to the longitudinal direction of the internal electrode layer 12 in the cross-sectional view, and in FIG. 2, it indicates the X-axial direction. In FIG. 5, the particles of the perovskite structure existing in the dielectric layer 11 are omitted for the sake of explanation, and the needle-shaped particles 40 are schematically shown in a linear shape. The needle-shaped particles 40 exist between the particles of the perovskite structure.

As shown in FIG. 5, the length Ln of the internal electrode layer 12 is defined as a length from one end to the other end in the longitudinal direction of the internal electrode layer 12, as observed in a cross-sectional view of a multilayer ceramic capacitor cut along the first-axis direction.

As shown in FIG. 5, the total projected length Lps of the needle-shaped particles 40 is a sum of projected lengths Lp of the needle-shaped particles 40 in the cross-sectional view taken by cutting the multilayer ceramic capacitor along the first axial direction, when projected along the first axis (X-axial direction) onto a plane parallel to the second axis and the third axis (perpendicular to the first axis), which pass through the internal electrode layer 12. The total projected length Lps in FIG. 5 is the sum of Lp1 to Lp4. As shown by the projected length Lp1 in FIG. 5, the projected length Lp may be calculated from projections of a plurality of needle-shaped particles 40. Even when the projections from the plurality of needle-shaped particles 40 overlap, the overlapping portion is not considered, and the projected length Lp is calculated based on a projection view projected onto a plane parallel to the second axis and the third axis (plane perpendicular to the first axis) passing through the internal electrode layer 12.

The total projected length ratio Lps/Ln in the multilayer ceramic capacitor according to the present embodiment is preferably 1% to less than 30%, and preferably 5% to less than 15%. A total projected length ratio Lps/Ln of 1% or more is preferable because the strength of the multilayer ceramic capacitor is improved. A total projected length ratio Lps/Ln of less than 30% is preferable because the electrostatic capacitance is improved. In addition, when the total projected length ratio Lps/Ln is 1% or more and less than 30%, penetration of needle-shaped particles through the internal electrode layer, which can occur in conventional multilayer ceramic capacitors, can be prevented, which improves characteristics such as yield, short-circuit ratio, and a service life. It should be noted that, in the present disclosure, high strength means that the yield of the multilayer ceramic capacitor after firing is high and that a failure occurrence rate due to dropping is low. Furthermore, in the present disclosure, excellent electrical characteristics mean that the electrostatic capacitance is large and that the service life is long.

The total projected length ratio Lps/Ln can be controlled by the size of the needle-shaped particles 40 contained in the dielectric layer-forming powder used for forming the dielectric layer 11 and the content of the needle-shaped particles 40 in the dielectric layer-forming powder.

The size of the needle-shaped particles 40 can be controlled by the synthesis conditions of the needle-shaped particles. The synthesis method of the needle-shaped particles 40 is not particularly limited and can be appropriately selected according to the purpose, and can be synthesized by, for example, the following method. Raw material powder and ethanol solution are mixed by using ball milling with zirconia beads, the zirconia beads are separated by a sieve or the like, and the ethanol is removed by drying at 100° C. to obtain the mixed powder. The needle-shaped particles 40 can be obtained by heat-treating the mixed powder in an atmospheric atmosphere at a temperature of 1100° C. to 1400° C. and by heat treatment for 30 minutes to 20 hours. The size of the needle-shaped particles 40 can be appropriately adjusted by controlling the composition of the raw material powder, the heat treatment temperature, the heat keeping time, and the like. Examples of materials contained in the raw material powder are as follows.

### -Raw Material Powder-

$${SiO}_{2} : {Al}_{2} {O}_{3} : {TiO}_{2} : {CaCO}_{3} : {Na}_{2} {CO}_{3} : {K}_{2} {CO}_{3} = 1 : 1.2 : 0.01 : 0.002 : 0.005 : 0.003 ( mol \% )$$

The content of the needle-shaped particles in the powder for forming the dielectric layer is preferably 0.2 mass % or more and 1.8 mass % or less from the viewpoint of obtaining a multilayer ceramic capacitor having high strength and excellent electrical characteristics.

The powder for forming the dielectric layer may contain spherical particles in addition to the perovskite compound and the needle-shaped particles 40. The spherical particles are not particularly limited and can be appropriately selected according to the purpose, and preferably contain silicon (Si) and aluminum (Al). Specific compositions of the spherical particles include, for example, Al₂Si₂O₅, Al₄Si₈O₂₂, Al₂O₃, SiO₂, Al₂O₃, SiO₂, and mixed powders of them.

The ratio of needle-shaped particles to spherical particles in the powder for forming the dielectric layer is preferably 10:90 to 90:10, more preferably 20:80 to 70:30, and more preferably 20:80 to 50:50 from the viewpoint of obtaining a multilayer ceramic capacitor having high strength and excellent electrical characteristics.

The method for measuring the length Ln and the total projected length Lps is not particularly limited, and can be appropriately selected according to the purpose, and can be measured, for example, by the following method. Using a scanning electron microscope (SEM) capable of identifying a composition of a sample based on a backscattered electron image, a partial cross section of the multilayer ceramic capacitor including the internal electrode layer in the YZ-plane or the XZ-plane is observed, and needle-shaped particles having a composition different from that of the dielectric material can be identified from a contrast difference in the backscattered electron image. Prior to observation by the SEM, the multilayer ceramic capacitor is cut by, for example, an ion milling method to obtain a smooth cross section suitable for observation. In the obtained backscattered electron image, Ln and Lps are measured by, for example, using image analysis software ImageJ. At this time, Ln may be measured by using a sum of measured values obtained from SEM photographs of a plurality of dielectric layers or a plurality of fields of view, and can be measured within a measurement range in which the sum of Ln is 300 times or more and 600 times or less the thickness of the dielectric layers. Alternatively, in the cross section of the multilayer ceramic capacitor, the total length of two or three dielectric layers at the central part in the lamination direction may be captured in SEM photographs of a plurality of fields, and the sum of the measured values obtained from the SEM photographs of the plurality of fields may be used. When the number of dielectric layers between the internal electrodes is even, two dielectric layers are measured, and when the number of dielectric layers between the internal electrodes is odd, three dielectric layers are measured.

The dielectric layer 11 may contain additives other than the above-described ceramic materials and needle-shaped particles 40. The additive is not particularly limited and can be appropriately selected according to the purpose, and examples include glass containing a simple substance or compound containing one or more elements selected from zirconium (Zr), magnesium (Mg), manganese (Mn), molybdenum (Mo), vanadium (V), chromium (Cr), rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb), or a simple substance or compound containing one or more elements selected from cobalt (Co), nickel (Ni), lithium (Li), boron (B), sodium (Na), potassium (K), and silicon (Si), or an oxide containing one or more elements selected from cobalt, nickel, lithium, boron, sodium, potassium, and silicon.

The dielectric layer 11 may contain copper (Cu). When the dielectric layer 11 contains copper, the concentration of copper in the dielectric layer 11 is preferably 0.1 atom % or less from the viewpoint of ensuring dielectric insulation.

The thickness (μm) of the dielectric layer 11 is preferably 0.6 μm or less, and preferably 0.2 μm or more. When the thickness of the dielectric layer 11 is 0.6 μm or less, it is possible to reduce the amount of needle-shaped particles per one layer required to develop high mechanical strength, and to reduce the total projected length ratio Lps/Ln. Therefore, it is possible to improve dielectric characteristics, and to achieve compatibility between mechanical strength and electrical characteristics. When the thickness of the dielectric layer 11 is 0.2 μm or more, it is possible to prevent needle-shaped particles from interfering with the internal electrode layer, and to improve reliability.

There is no particular limitation as a method for measuring the thickness (μm) of the dielectric layer 11, which can be appropriately selected according to the purpose, and can be evaluated, for example, based on cross-sectional observation of the multilayer ceramic capacitor 100. More specifically, the multilayer ceramic capacitor is polished along the X-axial direction or the Y-axial direction to expose the YZ-plane or the XZ-plane of the capacitance part 14. At this time, the surface to be exposed by polishing is preferably located near the center of the capacitance part 14 in the X-axial direction or the Y-axial direction. The exposed surface is imaged by a laser microscope or the like, and approximately five to ten layers, or fifteen to twenty layers in total, of the dielectric layer 11 are selected from the central part, the upper end part, and the lower end part in the Z-axial direction, which is the lamination direction of the dielectric layer 11. The thickness t (length in the Z-axial direction) of each of these dielectric layers 11 may be measured at positions corresponding to ¼, ½, and ¾ of a width of the dielectric layer, and an average of the measured values may be taken as the thickness t (μm) of the dielectric layer 11. When imaging by a laser microscope or the like, images may be taken separately at the central part, the upper end part, and the lower end part in the Z-axial direction, which is the lamination direction of the dielectric layer 11, or images may be taken separately at ¼, ½, and ¾ of the width of each dielectric layer.

### (Internal Electrode Layer)

The internal electrode layer 12 contains a metal or an alloy as a main component. The internal electrode layer 12 may contain, for example, a base metal such as nickel (Ni) or tin (Sn), or an alloy containing these as a main component. The internal electrode layer 12 may contain, as a main component, a noble metal such as platinum (Pt), palladium (Pd), silver (Ag) or gold (Au), or an alloy containing these. Among these, the internal electrode layer 12 preferably contains Ni from the viewpoint of excellent electrical characteristics and cost reduction.

The main component in the first internal electrode layer 12a and the main component in the second internal electrode layer 12b may be the same or different.

The internal electrode layer 12 may or may not contain, in addition to the main component metal, an additive metal element. When the internal electrode layer 12 contains an additive metal element, the additive metal element may include, for example, a metal which is nobler than the main component metal of the internal electrode layer 12. More specifically, one element or two or more elements selected from a group including Au (gold), Sn (tin), Cr (chromium), Y (yttrium), In (indium), As (arsenic), Co (cobalt), Cu (copper), Ir (iridium), Mg (magnesium), Os (osmium), Pd (palladium), Pt (platinum), Re (rhenium), Rh (rhodium), Ru (ruthenium), Se (selenium), Te (tellurium), W (tungsten), and Zn (zinc) can be mentioned. For example, the internal electrode layer 12 may contain copper (Cu). When the internal electrode layer 12 contains Ni as a main component, Cu may form an alloy with Ni. When the internal electrode layer 12 contains copper, interface resistance between the internal electrode layer and the dielectric layer is increased, and the service life of the MLCC is prolonged.

The concentration (atom %) of copper in the internal electrode layer 12 is not particularly limited and may be appropriately selected depending on the intended purpose; however, it is preferably 2.5 atom % or less, more preferably 2 atom % or less, still more preferably 1.5 atom % or less, and particularly preferably 1 atom % or less. When the concentration (atom %) of copper in the internal electrode layer 12 is set within the above range, it is possible to prevent a decrease in continuity of the internal electrode layer 12 that would otherwise be caused by a reduction in its melting point due to an excessive amount of copper present in the internal electrode layer 12. Further, from the viewpoint of improving lifetime characteristics, the concentration (atom %) of copper in the internal electrode layer 12 is preferably 0.2 atom % or more, more preferably 0.3 atom % or more, and still more preferably 0.5 atom % or more.

The method for measuring the concentration of copper in the internal electrode layer 12 is not particularly limited and can be appropriately selected according to the purpose, and can be, for example, an average value of the concentration (atom %) of copper in the region of the internal electrode layer 12 in a graph of the concentration distribution obtained by TEM-EDX analysis. If a strict boundary is required, the region of the internal electrode layer 12 may be a region where the concentration of oxygen is less than 5 atom %. Here, the concentration of copper is a ratio of atoms to all elements contained in the internal electrode layer 12.

The thickness of the internal electrode layer 12 is not particularly limited and can be appropriately selected according to the purpose, but is preferably from 0.1 μm to 1.5 μm, and more preferably from 0.3 μm to 1.0 μm.

When the thickness of the internal electrode layer 12 is 0.1 μm or more, a function as an internal electrode can be secured. When the thickness of the internal electrode layer 12 is 1.5 μm or less, the electrostatic capacitance can be increased by increasing the number of layers of the capacitance part 14 in a multilayer ceramic capacitor of the same size. In other words, when the thickness of the internal electrode layer 12 is 1.5 μm or less, it is preferable from the viewpoint of obtaining a smaller multilayer ceramic capacitor with the same performance. From the viewpoint of increasing the electrostatic capacitance by increasing the number of layers, the thickness of the internal electrode layer 12 is preferably 0.5 μm or less, and more preferably 0.4 μm or less.

The method for measuring the thickness of the internal electrode layer 12 is not particularly limited and can be appropriately selected according to the purpose, and can be measured, for example, by a method similar to the method for measuring the thickness of the dielectric layer 11.

### [Method of Manufacturing Multilayer Ceramic Capacitor]

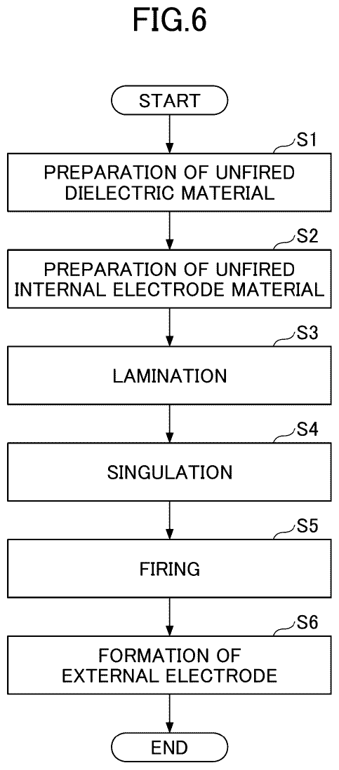

Next, a method for manufacturing the multilayer ceramic capacitor 100 described above will be described. One embodiment of the present disclosure is a method for manufacturing a multilayer ceramic capacitor, which includes a body in which a dielectric layer and an internal electrode layer are alternately laminated in the direction of the first axis, wherein the dielectric layer includes a perovskite-type compound represented by the general formula ABO₃ and needle-shaped particles containing silicon (Si) and aluminum (Al), including a laminating process of alternately laminating an unfired dielectric material to be a dielectric layer and an unfired internal electrode material to be an internal electrode layer to obtain a laminated body, and a firing process of firing the laminated body, wherein the thickness of the dielectric layer is 0.6 μm or less, and a ratio Lps/Ln of a total projected length Lps when the needle-shaped particles are projected from the direction of the first axis to a length Ln in the longitudinal direction of the internal electrode layer in a cross-sectional view of the multilayer ceramic capacitor cut in the direction of the first axis is 1% or more and less than 30%. FIG. 6 is a flowchart illustrating a method of manufacturing a multilayer ceramic capacitor 100 according to one embodiment.

### (Unfired Dielectric Material Preparation Process (S1))

In an unfired dielectric material preparation process (S1), a ceramic green sheet (unfired dielectric material) which becomes the dielectric layer 11 by firing is prepared.

First, a powder for forming a dielectric layer is prepared. The powder for forming a dielectric layer includes ceramic powder and needle-shaped particles containing silicon (Si) and aluminum (Al).

The ceramic powder may be a powder of the ceramic material described above for the dielectric layer 11 of the multilayer ceramic capacitor 100. Therefore, the ceramic powder may include a powder of a perovskite-type compound represented by the general formula ABO₃, and preferably contains barium titanate.

A predetermined additive may be added to the powder for forming a dielectric layer according to the purpose. The powder for forming a dielectric layer is wet mixed with or without adding the additive, and then dried and pulverized. Then, a binder such as a polyvinyl butyral (PVB) resin, an organic solvent such as ethanol and toluene, and a plasticizer are added and wet mixed to prepare a slurry for forming a dielectric layer. The obtained slurry for forming a dielectric layer is coated on a substrate such as a polyethylene terephthalate (PET) film by a method such as a die coater method or a doctor blade method, and dried to obtain a ceramic green sheet (an unfired dielectric layer material).

As a coating method of the slurry for forming a dielectric layer, a die coater method is preferable from the viewpoint that the ratio Lps/Ln of the length Ln of the internal electrode layer 12 and the total projected length Lps of the needle-shaped particles is 1% or more and less than 30%, and the content of the needle-shaped particles can be easily controlled. When the die coater method is employed as the coating method of the slurry for forming the dielectric layer, the content of the needle-shaped particles can be controlled by the content of the needle-shaped particles 40 in the powder for forming the dielectric layer used for forming the dielectric layer 11, the viscosity of the slurry for forming the dielectric layer, the coating speed of the slurry for forming the dielectric layer, the thickness of the ceramic green sheet, and the like. When the coating speed of a slurry for forming the dielectric layer is reduced, shear force at a die outlet tip is weakened, which facilitates control of an orientation of the needle-shaped particles 40 in a direction perpendicular to the substrate. In addition, by widening a gap at a die outlet of a coater, the slurry for forming the dielectric layer passes through an increased gap, which also facilitates control of the orientation of the needle-shaped particles 40 in the direction perpendicular to the substrate.

A specific conveying speed of the substrate and a discharging speed of the slurry for forming the dielectric layer are different depending on the coater. For example, by setting the conveying speed of the substrate to 0.5 times or less a normal speed and setting the discharging speed of the slurry for forming the dielectric layer to 0.5 times or less the normal speed in accordance with the conveying speed of the substrate, the coating speed of the slurry for forming the dielectric layer can be 0.5 times the normal speed while maintaining the thickness of the ceramic green sheet and adjusting the shear force. In addition, by setting the conveying speed of the substrate to ⅓ times or less of the normal speed and setting the discharging speed of the slurry for forming the dielectric layer to ⅓ times or less of the normal speed in accordance with the conveying speed of the substrate, the coating speed of the slurry for forming the dielectric layer can be ⅓ times or less the normal speed.

### (Unfired Internal Electrode Material Preparation Process (S2))

In an unfired internal electrode material preparation process (S2), the unfired internal electrode material to be the internal electrode layer 12, that is, the first internal electrode layer 12a and the second internal electrode layer 12b is prepared. The metal as the main component of the unfired internal electrode material may be a metal material similar to the material described above for the internal electrode layer 12 of the multilayer ceramic capacitor 100, such as a base metal such as Ni or Sn, or an alloy containing these metals. The metal material may also be a noble metal such as Pt, Pd, Ag, or Au, or an alloy containing these metals. It is preferable that the metal material contains Ni, and it is more preferable that Ni is the main component, because the metal material has excellent electrical characteristics and can reduce costs.

The metal material may or may not contain an additive metal element in addition to the main component metal. When the metal material contains an additive metal element, the additive metal element may include, for example, a metal which is nobler than the main component metal of the internal electrode layer 12. More specifically, one element or two or more elements selected from a group including of Au (gold), Sn (tin), Cr (chromium), Y (yttrium), In (indium), As (arsenic), Co (cobalt), Cu (copper), Ir (iridium), Mg (magnesium), Os (osmium), Pd (palladium), Pt (platinum), Re (rhenium), Rh (rhodium), Ru (ruthenium), Se (selenium), Te (tellurium), W (tungsten), and Zn (zinc) can be mentioned. For example, when the main component metal of the internal electrode layer 12 is Ni, Cu may be added. Then, the metal material after the addition of Cu, the organic binder, and the solvent are kneaded to obtain a metal paste (unfired internal electrode material). It is to be noted that Cu may be added after the metal paste is prepared from the main component metal material. Cu is preferably added as an oxide in the firing process. Examples of the oxide of Cu include copper oxide.

The amount and size of the needle-shaped particles added to the unfired internal electrode material can be adjusted so that the ratio Lps/Ln of the total projected length Lps when the needle-shaped particles are projected from the first axial direction to the length Ln in the longitudinal direction of the internal electrode layer in the cross-sectional view obtained by cutting the multilayer ceramic capacitor after a firing process (S5) in the first axial direction is 1% or more and less than 30%. By adjusting the amount and size of the needle-shaped particles added as described above, the strength of the multilayer ceramic capacitor is improved, and the decrease in the electrostatic capacitance can be reduced because the electric field readily fringes. Furthermore, since penetration of the needle-shaped particles through the internal electrode layer, which can occur in the multilayer ceramic capacitor in the related art, can be prevented, characteristics such as yield, short-circuit ratio, and service life are improved. In this manner, the multilayer ceramic capacitor 100 having high strength and excellent electrical characteristics can be manufactured according to the present embodiment.

Ceramic powder may be added to the metal paste (unfired internal electrode material) as a co-material. The main component of the ceramic powder is preferably the same as the ceramic powder used in the unfired dielectric material preparation process (S1), although not particularly limited. When the ceramic powder is added as a co-material, it may be added at the time of kneading the metal paste.

### (Lamination Process (S3))

In a lamination process (S3), the metal paste obtained in the unfired internal electrode material preparation process (S2) is printed on the surface of the ceramic green sheet obtained in the unfired dielectric material preparation process (S1) by a method such as screen printing and gravure printing. Thus, the first internal electrode pattern to be the first internal electrode layer 12a and the second internal electrode pattern to be the second internal electrode layer 12b can be arranged on the surface of the ceramic green sheet. The method for forming the internal electrode pattern is not limited to printing, but can also be performed by methods such as plating, vacuum deposition, sputtering, and CVD using a mask.

The ceramic green sheet on which the metal paste is printed is laminated so that the internal electrode layer 12 is alternately drawn out to the pair of external electrodes 20a and 20b arranged in the longitudinal direction (X-axial direction) of the dielectric layer 11. For this lamination, a known technology can be used. For example, in order to form the side margin 16 as an outer region in the Y-axial direction in the capacitance part 14 on the side where the internal electrode layer 12 is not drawn out, an unfired dielectric material can be arranged in a peripheral region where the internal electrode pattern of the metal paste is not printed. When the ceramic green sheet on which the metal paste is printed is used as a lamination unit, the number of layers in a lamination unit can be 100 to 500.

Subsequently, a laminated body is obtained by laminating a cover sheet as an unfired cover material for forming a cover layer on the upper and lower sides of the laminated body where the ceramic green sheet and the internal electrode pattern are obtained, that is, on both sides in the lamination direction (Z-axial direction). The cover sheet may be formed by the same method as the unfired dielectric material for forming a dielectric layer by mainly using ceramic powder. The cover sheet may be formed from the same material as the unfired dielectric material for forming a dielectric layer. The number of laminations of the cover sheet may be two to ten layers per one side.

A pressed body is obtained by pressing the obtained laminated body in the lamination direction (Z-axial direction).

### (Singulation Process (S4))

The pressed body can be cut to a predetermined size by dicing with a dicer, laser cutting or the like, and singulated. For the method of singulation, an existing technology can be used as appropriate.

### (Firing Process (S5))

In a firing process (S5), the individual laminated bodies are fired. Firing conditions are not particularly limited and may be appropriately selected depending on the intended purpose; however, a hydrogen concentration is preferably 0.03 vol. % or more and 1.0 vol. % or less, and more preferably 0.05 vol. % or more and 0.3 vol. % or less. The remainder of the reducing atmosphere other than hydrogen is nitrogen or argon. In the firing process (S5), Cu previously added to an unsintered material segregates or diffuses to an interface, and an intermediate region is formed.

The firing temperature in the firing process (S5) is preferably 1,000° C. or more and 1,350° C. or less, and more preferably 1,150° C. or more and 1,300° C. or less. The firing time in the firing process (S5) may be 30 minutes or more and two hours or less.

### (External Electrode Formation Process (S6))

In the external electrode formation process, the first external electrode 20a and the second external electrode 20b can be formed by plating or the like. Thus, the multilayer ceramic capacitor 100 described above is completed.

### EXAMPLES

Hereinafter, the present disclosure will be described in more detail based on examples.

### Example 1

### <Preparation of Multilayer Ceramic Capacitor>

The raw material powder and the ethanol solution were ball-milled with zirconia beads, and the zirconia beads were separated by a sieve or the like, and dried at 100° C. to remove ethanol, thereby obtaining a mixed powder. The mixed powder was heat-treated at a temperature of 1100° C., heat keeping time of five hours in an atmospheric atmosphere to obtain needle-shaped particles (L: 0.15 μm, W: 0.02 μm). The materials contained in the raw powder are as follows.

### -Raw Powder-

$${SiO}_{2} : {Al}_{2} {O}_{3} : {TiO}_{2} : {CaCO}_{3} : {Na}_{2} {CO}_{3} : {K}_{2} {CO}_{3} = 1 : 1.2 : 0.01 : 0.002 : 0.005 : 0.003 ( mol \% )$$

Spherical particles were synthesized by heat-treating raw powder mixed with SiO₂: Al₂O₃=1:1.2 (molar ratio) at 800° C. for two hours.

As shown in Table 1, a ceramic slurry was prepared by adding polyvinyl butyral (PVB) resin, a solvent, a plasticizer, a sintering aid powder which is a Si compound, and additives such as rare earth elements to a powder for forming a dielectric layer including barium titanate, acicular particles, and spherical particles, and wet-mixing. The ceramic slurry was coated on a substrate film using a doctor blade, and a dielectric green sheet was formed so that the thickness of the dielectric layer after sintering was 0.5 μm.

Cu was added to nickel powder in the form of copper oxide (CuO) powder, and mixed to prepare a mixed powder. A polyvinyl butyral (PVB) resin, a solvent, and a plasticizer were added to the mixed powder, and kneaded to obtain a metal paste for preparing an internal electrode layer. The metal paste was printed on a dielectric green sheet to form an internal electrode layer pattern.

A laminated body was obtained by laminating 500 dielectric green sheets on which such a metal paste was printed, and further arranging dielectric green sheets serving as cover layers on both sides in the lamination direction.

The obtained laminated body was pressed and then cut to a predetermined size to obtain an individual molded chip. The molded chip was debound in an N2 atmosphere, and a metal paste as an underlying layer of the external electrode was applied by using a dip method. Subsequently, the molded chip was placed in a firing furnace, and the temperature of the firing furnace (firing temperature) was raised to 1200° C. in an atmosphere of H₂ concentration of 0.1 vol % and N2 concentration of 99.9%, and firing was performed for 10 minutes. External electrodes were formed on the molded chip after firing by plating, and a multilayer ceramic capacitor (MLCC) with a size of 1.0 mm×0.5 mm×0.5 mm was obtained.

### [Measurement of Length Ln, Total Projected Length Lps, And Total Projected Length Ratio Lps/Ln]

A part of the cross-section including the internal electrode layer of the multilayer ceramic capacitor on the YZ-plane or the XZ-plane was photographed by a scanning electron microscope (SEM, Hitachi Hitech, SU8220), which can identify the composition of a sample by a backscattered electron image. Needle-shaped particles with a composition different from the dielectric composition were identified from the contrast difference of the backscattered electron image. Prior to observation by SEM, the multilayer ceramic capacitor was cut by an ion milling method to obtain a smooth cross-section suitable for observation. The Ln and Lps of the backscattered electron image were measured using image analysis software ImageJ. At this time, Ln was measured in a measurement range in which the sum of Ln was 300 times or more and 600 times or less the dielectric layer thickness, using the sum of measured values obtained from SEM photographs of a plurality of dielectric layers and a plurality of fields of view. The total projected length ratio Lps/Ln was calculated by dividing the total projected length Lps of the needle-shaped particles observed in the range by the sum of Ln.

### [Strength Evaluation]

### <Number of Defects in Manufacturing Process>

In a manufacturing process of a multilayer ceramic capacitor, 100 devices having no abnormalities at the completion of the singulation process were selected, and, after undergoing a debinding process, a firing process, and an external electrode formation process, the devices were subjected to visual inspection. Devices that had abnormalities such as cracks or chips were counted, and the number of defects was calculated. “Cracks” and “chips” are defined as cracks or chips if the diameter of the cracks or chips (when a circumscribed circle is drawn) that can be confirmed from the visual appearance is 3% or more of the long side of the device. For example, if the long side of the device is 1.0 mm, cracks or chips of 0.030 mm or more are counted as abnormalities. The results are shown in Table 1.

### <Number of Short Circuits>

Out of 100 manufactured multilayer ceramic capacitors, a DC voltage of 1 V was applied between the external electrodes of each multilayer ceramic capacitor in which no defect was generated, and the number of samples in which electric resistance between the external electrodes was less than 1 kΩ was defined as the number of short circuits. The results were shown in Table 1.

### <Yield>

Out of 100 manufactured multilayer ceramic capacitors, the percentage of the manufactured multilayer ceramic capacitors that were free from defects or short circuits was defined as the yield, and the results were shown in Table 1. The multilayer ceramic capacitors with a yield of 100% were determined as “good”, that is, acceptable, and the other multilayer ceramic capacitors were determined as “fail”, that is unacceptable.

### <Failure Rate Due to Dropping>

Several hundred to a thousand of multilayer ceramic capacitors were dropped onto a stainless steel plate from a height of 180 cm, and the failure rate after dropping was evaluated. Here, the failure rate means the short circuit rate. A DC voltage of 1 V was applied between the external electrodes of the multilayer ceramic capacitors after dropping, and the ratio of the number of samples in which electric resistance between the external electrodes was less than 1 kΩ was defined as the short circuit rate. A multilayer ceramic capacitor with poor mechanical strength is an index of mechanical strength because a crack occurs and a short circuit failure occurs. The results are shown in Table 1. The multilayer ceramic capacitor with a failure occurrence rate of 0% was determined as acceptable and determined as “good”. The other multilayer ceramic capacitors were determined as unacceptable and determined as “fail”.

### [Electrical Characteristic Evaluation]

### <Electrostatic Capacitance>

The manufactured multilayer ceramic capacitor was left at 150° C. for one hour and then left under standard conditions (Temperature: 25° C., 1 atm) for 24 hours. Subsequently, the electrostatic capacitance (μF) was measured using an LCR meter (HP4284A manufactured by Keysight Technologies) under the conditions of a voltage of 0.5 V and a frequency of 1 kHz. The results are shown in Table 1. The electrostatic capacitance of each multilayer ceramic capacitor is shown, assuming that the electrostatic capacitance of the multilayer ceramic capacitor in Comparative Example 1 is 100. A multilayer ceramic capacitor having electrostatic capacitance of 95% or more was determined acceptable. A multilayer ceramic capacitor with electrostatic capacitance of 110% or more was determined as “excellent”, a multilayer ceramic capacitor with electrostatic capacitance of 100% or more but less than 110% was determined as “good”, a multilayer ceramic capacitor with electrostatic capacitance of 95% or more but less than 100% was determined as “marginal”, and the other multilayer ceramic capacitors were determined as “fail”.

### <Lifetime Characteristics>

Lifetime characteristics were evaluated by a highly accelerated life test (HALT). A voltage of 9.0 V was applied at 150° C. to each of 20 multilayer ceramic capacitors without defects or short circuits, and leak currents were measured with time. The time at which 50% of the samples had a leak current of 2000 μA was recorded as a HALT service life of 50%. The results are shown in Table 1. The service life of each multilayer ceramic capacitor is shown, assuming that the service life of the multilayer ceramic capacitor in Comparative Example 1 is 100. A multilayer ceramic capacitor with a service life of 100% or more was determined acceptable. A multilayer ceramic capacitor with a service life of 200% or more was determined as “excellent”, a multilayer ceramic capacitor with a service life of 100% or more but less than 200% was determined as “good”, and other multilayer ceramic capacitors were determined as “fail”.

### Examples 2 to 7 and Comparative Examples 1 to 7

As shown in Table 1, the multilayer ceramic capacitors were prepared in the same manner as in Example 1 except that the composition of the powder for forming the dielectric layer was changed, and the capacitors were evaluated in the same manner. The results are shown in Table 1.

### [Table 1]

| | Content with Respect | | | | | | | | |
|---|---|---|---|---|---|---|---|---|---|
| | to Barium Titanate | | | Thickness | Length of Internal | | | | |
| | [mass %] | | | of Dielectric | Electrode Layer Ln | | | Strength Evaluation | |
| | | | Weight | Layer | and Total Projected | | | | Number |
| | Needle- | | Ratio | After | Length Lps | | | Number | of |
| | shaped | Spherical | [Needle/ | Firing | Lps | Ln | Lps/ | of | Short |
| | Particles | Particles | Sphere] | [μm] | [μm] | [μm] | Ln | Defects | Circuits |
| Example 1 | 0.2 | 1.8 | 10/90 | 0.5 | 2.8 | 199 | 1.4% | 0 | 0 |
| Example 2 | 0.4 | 1.6 | 20/80 | 0.5 | 11.1 | 207 | 5.4% | 0 | 0 |
| Example 3 | 0.6 | 1.4 | 30/70 | 0.5 | 21.8 | 207 | 10.6% | 0 | 0 |
| Example 4 | 1 | 1 | 50/50 | 0.5 | 29.8 | 203 | 14.7% | 0 | 0 |
| Example 5 | 1.4 | 0.6 | 70/30 | 0.5 | 42.6 | 203 | 21.0% | 0 | 0 |
| Example 6 | 1.7 | 0.3 | 85/15 | 0.5 | 61.2 | 207 | 29.6% | 0 | 0 |
| Example 7 | 1.7 | 0.3 | 70/30 | 0.6 | 51.3 | 207 | 24.8% | 0 | 0 |
| Comparative | 2 | 0 | 100/0 | 0.5 | 86.7 | 206 | 42.1% | 3 | 13 |
| Example 1 | | | | | | | | | |
| Comparative | 1.7 | 0.3 | 85/15 | 0.65 | 43.2 | 207 | 20.9% | 0 | 1 |
| Example 2 | | | | | | | | | |
| Comparative | 1.9 | 0.1 | 95/5 | 0.5 | 64.9 | 208 | 31.2% | 1 | 2 |
| Example 3 | | | | | | | | | |
| Comparative | 0.1 | 1.9 | 5/95 | 0.5 | 1.0 | 197 | 0.5% | 14 | 0 |
| Example 4 | | | | | | | | | |
| Comparative | 0 | 2 | 0/100 | 0.5 | 0.0 | 204 | 0.0% | 17 | 0 |
| Example 5 | | | | | | | | | |
| Comparative | 0.6 | 1.4 | 30/70 | 1 | 82.0 | 402 | 20.4% | 8 | 2 |
| Example 6 | | | | | | | | | |
| Comparative | 0.2 | 1.8 | 10/90 | 3 | 197.0 | 998 | 19.7% | 17 | 1 |
| Example 7 | | | | | | | | | |

| | Strength Evaluation | | | | | | | |
|---|---|---|---|---|---|---|---|---|
| | | | Failure | | | | | |
| | | | Rate | | Electrical Characteristic Evaluation | | | |
| | | Good | due | Good | Electro- | | | |
| | | or | to | or | static | Evaluation | Service | Evaluation |
| | Yield | Fail | Dropping | Fail | Capacitance | Grade | Life | Grade |
| Example 1 | 100% | Good | 0% | Good | 113.5 | Excellent | 198 | Good |
| Example 2 | 100% | Good | 0% | Good | 113.4 | Excellent | 223 | Excellent |
| Example 3 | 100% | Good | 0% | Good | 113.4 | Excellent | 223 | Excellent |
| Example 4 | 100% | Good | 0% | Good | 111.2 | Excellent | 205 | Excellent |
| Example 5 | 100% | Good | 0% | Good | 109.0 | Good | 190 | Good |
| Example 6 | 100% | Good | 0% | Good | 104.5 | Good | 132 | Good |
| Example 7 | 100% | Good | 0% | Good | 95.5 | Marginal | 145 | Good |
| Comparative | 84% | Fail | 0% | Good | 100 | Good | 100 | Good |
| Example 1 | | | | | | | | |
| Comparative | 99% | Fail | 0% | Good | 90.3 | Fail | 166 | Good |
| Example 2 | | | | | | | | |
| Comparative | 97% | Fail | 0% | Good | 103.8 | Good | 126 | Good |
| Example 3 | | | | | | | | |
| Comparative | 86% | Fail | 0.3% | Fail | 115.1 | Excellent | 226 | Excellent |
| Example 4 | | | | | | | | |
| Comparative | 83% | Fail | 0.5% | Fail | 115.5 | Excellent | 230 | Excellent |
| Example 5 | | | | | | | | |
| Comparative | 90% | Fail | 0% | Good | 54.2 | Fail | 185 | Good |
| Example 6 | | | | | | | | |
| Comparative | 82% | Fail | 0% | Good | 18.0 | Fail | 188 | Good |
| Example 7 | | | | | | | | |

As shown in Table 1, the multilayer ceramic capacitors of Examples 2 to 4 having a total projected length ratio Lps/Ln of 5 to 15% showed satisfactory strength evaluation and electrical characteristic evaluation. The multilayer ceramic capacitors of Example 1 and Examples 5 to 7 having a total projected length ratio Lps/Ln of 1% to 30% showed satisfactory strength evaluation and electrical characteristic evaluation, although they were slightly inferior to the multilayer ceramic capacitors of Examples 2 to 4.

Conversely, the multilayer ceramic capacitors of Comparative Examples 1 and 3, in which the total projected length ratio Lps/Ln exceeded 30%, showed poor results in the evaluation of the yield after firing. The multilayer ceramic capacitor of Comparative Example 4, in which the total projected length ratio Lps/Ln was less than 1%, and the multilayer ceramic capacitor of Comparative Example 5, in which needle-shaped particles were not included, showed poor results in the evaluation of the yield after firing and the evaluation of the failure occurrence rate due to dropping. The multilayer ceramic capacitors of Comparative Examples 2, 6, and 7, in which the thickness of the dielectric layer was greater than 0.6 μm, showed poor results in the evaluation of the yield after firing, and the value of the electrostatic capacitance also decreased due to the increase in the thickness of the dielectric layer.

Further, the present invention is not limited to these embodiments, and various variations and modifications may be made without departing from the scope of the present invention.

The aspects of the present disclosure are, for example, as follows.

<1> A multilayer ceramic capacitor including a base body in which a dielectric layer and an internal electrode layer are alternately laminated in a first axial direction, wherein:
the dielectric layer includes a perovskite-type compound represented by a general formula ABO₃ and needle-shaped particles containing silicon (Si) and aluminum (Al);
a thickness of the dielectric layer is 0.6 μm or less; and
in a cross-sectional view taken by cutting the multilayer ceramic capacitor along the first axial direction, a ratio Lps/Ln of a total projected length Lps of the needle-shaped particles to a longitudinal length Ln of the internal electrode layer is 1% or more and less than 30%, the total projected length Lps being a sum of projected lengths of the needle-shaped particles in the cross-sectional view when projected along the first axial direction onto a plane perpendicular to the first axial direction.

<2> The multilayer ceramic capacitor according to <1>, wherein the thickness of the dielectric layer is 0.2 μm or more.

<3> The multilayer ceramic capacitor according to <1> or <2>, wherein the ratio Lps/Ln is 5% or more and 15% or less.

<4> The multilayer ceramic capacitor according to any one of <1> to <3>, wherein the perovskite-type compound includes barium titanate.

What is claimed is:

1. A multilayer ceramic capacitor comprising a base body in which a dielectric layer and an internal electrode layer are alternately laminated in a first axial direction, wherein:
the dielectric layer includes a perovskite-type compound represented by a general formula ABO₃ and needle-shaped particles containing silicon (Si) and aluminum (Al);
a thickness of the dielectric layer is 0.6 μm or less; and
in a cross-sectional view taken by cutting the multilayer ceramic capacitor along the first axial direction, a ratio Lps/Ln of a total projected length Lps of the needle-shaped particles to a longitudinal length Ln of the internal electrode layer is 1% or more and less than 30%, the total projected length Lps being a sum of projected lengths of the needle-shaped particles in the cross-sectional view when projected along the first axial direction onto a plane perpendicular to the first axial direction.

2. The multilayer ceramic capacitor according to claim 1, wherein
the thickness of the dielectric layer is 0.2 μm or more.

3. The multilayer ceramic capacitor according to claim 1, wherein
the ratio Lps/Ln is 5% or more and 15% or less.

4. The multilayer ceramic capacitor according to claim 1, wherein
the perovskite-type compound includes barium titanate.
